(19) United States
(12) Patent Application Publication
(10) Pub. No.: US 2026/0019885 A1
(43) Pub. Date: Jan. 15, 2026

(54) OPERATING CUSTOMER PREMISE EQUIPMENT FOR SIGNAL DETECTION WITH REDUCED PATH LOSS

(71) Applicant: T-Mobile USA, Inc., Bellevue, WA (US)

(72) Inventor: Chad C. Au, Kirkland, WA (US)

(21) Appl. No.: 18/921,594

(22) Filed: Oct. 21, 2024

Related U.S. Application Data
(63) Continuation-in-part of application No. 18/769,817, filed on Jul. 11, 2024.

(51) Int. Cl. H04W 28/24; H04W 84/12

(52) U.S. Cl. CPC H04W 28/24; H04W 84/12

(57) ABSTRACT

The technology is directed to activating a wireless modem within a Customer Premise Equipment (CPE) to initiate signal detection. The wireless modem includes one or more Rydberg sensors containing one or more transmit antennas having one or more Rydberg atoms. The Rydberg atom sensors can be used to detect electromagnetic fields of downlink data transmissions from a base station while avoiding electric field distortion from one or more metallic members of the transmit antennas, impedance from the metallic members, and/or insertion loss from a duplexer of the CPE. The transmit antennas transmit uplink data transmissions to the base station for a service provided to a subscriber associated with the CPE. The CPE routes both the downlink data transmissions and the uplink data transmissions for the service provided to the subscriber.

### CROSS-REFERENCE TO RELATED APPLICATIONS

This application is a continuation-in-part of U.S. Patent Application No. 18/769,817 entitled “CUSTOMER PREMISE EQUIPMENT FOR FIXED-WIRELESS ACCESS USING RYDBERG ATOM SENSORS” and filed July 11, 2024.

### BACKGROUND

Customer Premise Equipment (CPE) refers to telecommunications hardware that is located at an end user's premises and is used to connect to a service provider's network. A CPE is any terminal and associated equipment located at a subscriber's premises and connected with a carrier's telecommunication circuit at the demarcation point ("demarc"). The demarc is a point established in a building or complex to separate customer equipment from the equipment located in either the distribution infrastructure or central office of the communications service provider. CPE generally refers to devices such as telephones, routers, network switches, residential gateways (RG), set-top boxes, fixed mobile convergence products, home networking adapters, and Internet access gateways that enable consumers to access providers' communication services and distribute them in a residence or enterprise with a local area network (LAN). A CPE can be active equipment, such as the ones mentioned above, or passive equipment such as analog telephone adapters (ATA) or xDSL-splitters. However, conventional CPEs can sometimes fall short in terms of performance and reliability, especially in challenging environments where signal strength and quality may fluctuate. Consequently, users may experience inconsistent service quality, slower data speeds, and frequent connectivity disruptions.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a drawing that illustrates an example environment of a Customer Premise Equipment (CPE) in which at least some operations described herein can be implemented.

FIG. 4A is a drawing that illustrates an example CPE for fixed-wireless access.

FIG. 4B is a drawing that illustrates an example CPE for fixed-wireless access using Rydberg atom sensors that can implement aspects of the present technology.

FIG. 5 is a flowchart that illustrates a process for implementing a CPE for fixed-wireless access using Rydberg atom sensors that can implement aspects of the present technology.

FIG. 6 is a block diagram that illustrates an example environment of using a CPE with Rydberg atom sensors for signal detection that can implement aspects of the present technology.

FIG. 7 is a flowchart that illustrates a process for implementing a CPE with Rydberg atom sensors for signal detection that can implement aspects of the present technology.

FIG. 8 is a flowchart that illustrates a process for implementing a CPE with Rydberg atom sensors for signal detection that can implement aspects of the present technology.

FIG. 9 is a block diagram that illustrates an example of a computer system in which at least some operations described herein can be implemented.

The technologies described herein will become more apparent to those skilled in the art from studying the Detailed Description in conjunction with the drawings. Implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The telecommunications industry has witnessed rapid advancements over the past few decades, with significant improvements in the ways data is transmitted and received. Among these advancements, Fixed-Wireless Access (FWA) has emerged as a vital technology for providing high-speed internet services, particularly in areas where traditional wired infrastructure is impractical or cost-prohibitive. FWA uses wireless communication technologies to deliver broadband connectivity to homes and businesses, utilizing base stations to communicate with Customer Premise Equipment (CPE) located at the user’s premises.

Conventional CPEs typically consist of components such as modems, routers, and power supplies. The devices are responsible for receiving data transmissions from a base station, processing the data, and distributing it within the user's local network. Despite their widespread use, traditional CPEs often encounter limitations that affect their performance. Issues such as signal degradation, interference, and the need for complex baseband processing can result in inconsistent service quality and reduced data transmission speeds. Challenges with conventional CPEs are particularly pronounced in environments with high levels of radio frequency (RF) noise or where the signal path between the base station and the CPE is obstructed (e.g., due to obstacles such as buildings or trees).

The disclosed technology relates to operating a CPE for FWA that incorporates Rydberg atom sensors to improve signal detection and processing by reducing path loss. The CPE can include a wireless modem that includes one or more Rydberg sensors, which contain transmit antennas equipped with Rydberg atoms. The Rydberg sensors can detect electromagnetic fields of downlink data transmissions from a base station while avoiding electric field distortion, impedance from metallic members of the transmit antennas, and/or insertion loss from a duplexer in the CPE. The CPE can transmit uplink data transmissions to the base station for services provided to a subscriber associated with the CPE, identified via a subscriber identity module in the wireless modem. The wireless modem can convert downlink and/or uplink data transmissions to an Internet Protocol (IP) format. A Wi-Fi router within the CPE can obtain the IP-formatted transmissions from the wireless modem and route the transmissions for the service provided to the subscriber.

The disclosed technology addresses the issues associated with conventional CPEs, such as signal degradation due to interference and obstructions, the complexity of baseband processing, and inefficiencies in handling high data rates. By using the properties of Rydberg atoms, which exhibit highly sensitive responses to electromagnetic fields, the disclosed technology enables more precise and efficient demodulation of downlink transmissions, thereby improving overall connection stability and speed. Using CPEs integrated with Rydberg sensors leads to faster, more stable network connections for subscribers, even in areas with challenging environmental conditions or obstacles.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

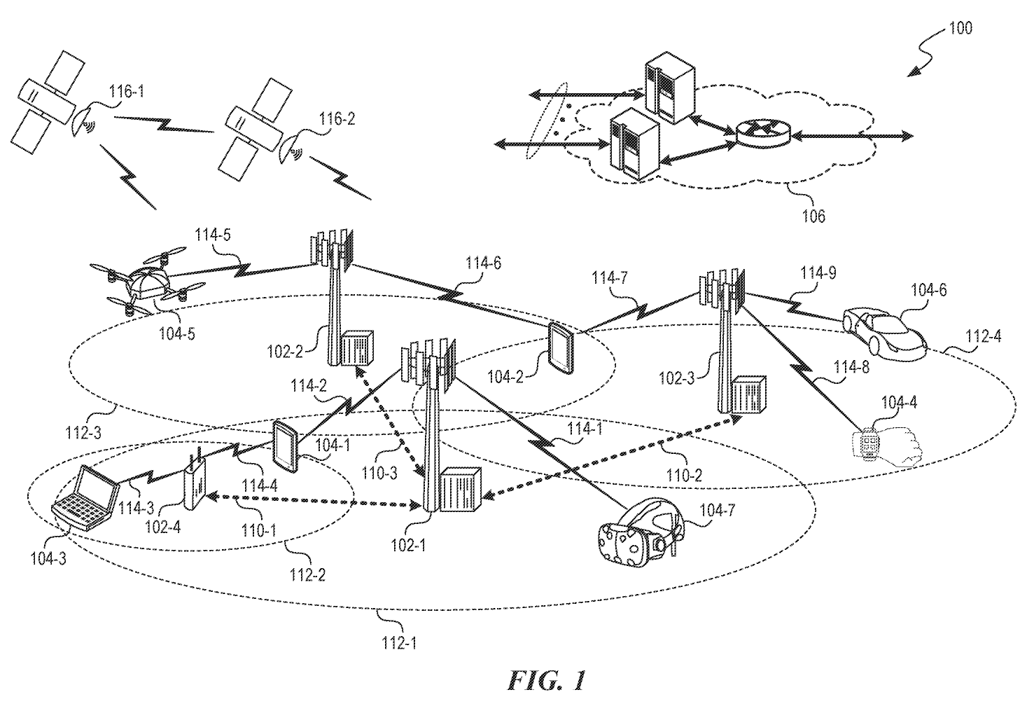

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, IP connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a non-terrestrial network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

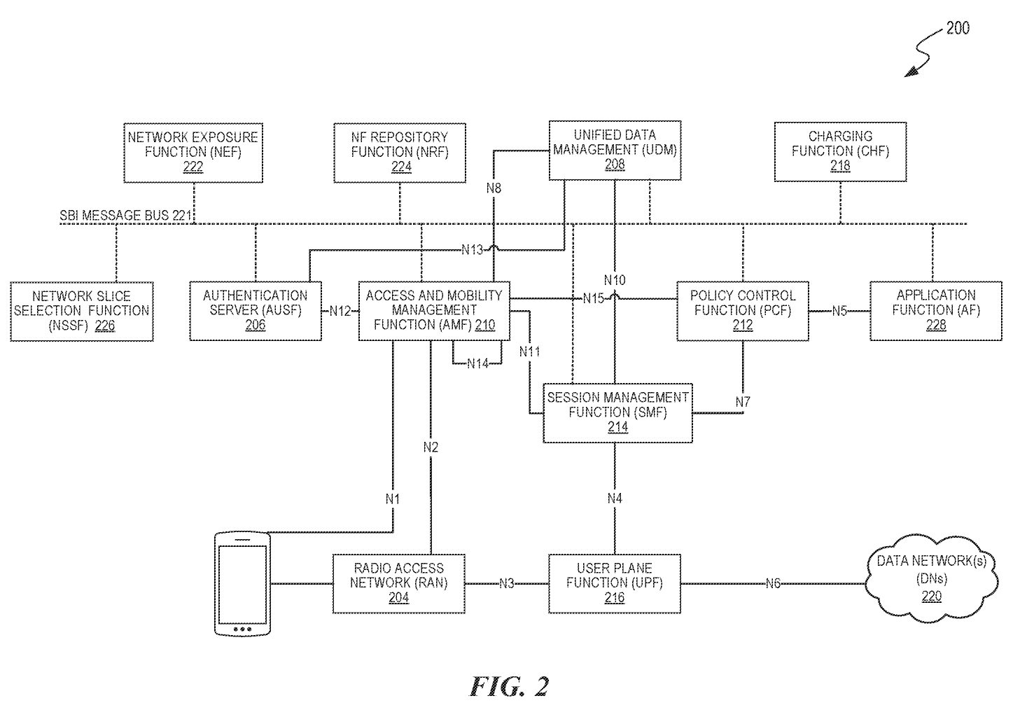

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Customer Premise Equipment for Fixed-Wireless Access Using Rydberg Atom Sensors

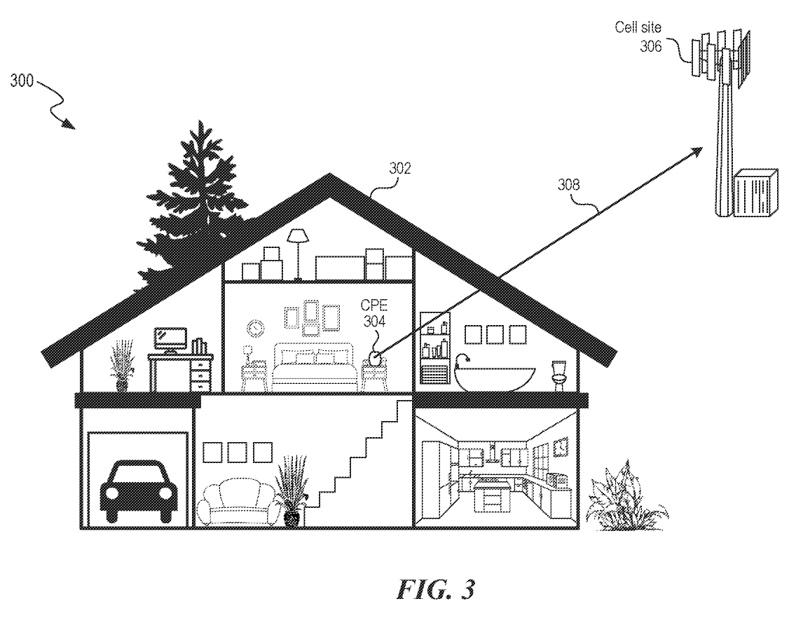

FIG. 3 is a diagram that illustrates an example environment 300 of a CPE in which at least some operations described herein can be implemented. Environment 300 includes obstacle 302, consumer premise equipment (CPE) 304, cell site 306, and radio signal 308. CPE 304 can be fixed-wireless access devices illustrated and described in more detail with reference to FIG. 1. The cell site can be a network access node (NAN) illustrated and described in more detail with reference to FIG. 1. Likewise, implementations of environment 300 can include different and/or additional components or can be connected in different ways.

CPE 304 includes hardware installed at a customer's location that facilitates connectivity to a service provider's network. The CPE can include a wireless modem equipped with transmit antennas. CPE 304 receives downlink data transmissions from cell site 306, converts the downlink data transmissions into an IP format, and transmits uplink data back to cell site 306. The CPE also typically includes a Wi-Fi router to distribute the internet connection within the customer's premises.

Cell site 306 is an infrastructure that provides wireless communication services to a specific geographic area. Cell site 306 can include antennas, transceivers, and other equipment necessary to send and receive radio signals 308 to and from CPE 304. Cell site 306 can connect to a broader network of the service provider, acting as a hub that facilitates data transmission between the user's CPE 304 and the internet. The performance and coverage of cell site 306 directly affect the consistency and quality of FWA services. The radio signal 308 travels through the environment to connect the CPE 304 with the broader network, enabling FWA services for the consumer. Radio signal 308 represents the electromagnetic waves used to transmit data between cell site 306 and CPE 304. Radio signals 308 can carry both downlink data (from the cell site 306 to the CPE 304) and uplink data (from the CPE 304 to the cell site 306).

The quality and strength of the radio signal 308 can be influenced by several factors, such as distance, frequency, and the presence of obstacles 302. Greater distances typically lead to signal attenuation and reduced radio signal 308 strength. Signal attenuation refers to the gradual loss of signal intensity as the radio signal 308 travels over a distance, resulting in a weaker signal by the time the radio signal 308 reaches the receiver. Additionally, the frequency of the radio signal 308 affects the radio signal’s 308 propagation characteristics, which describe how the signal travels through the environment. Higher frequencies offer greater bandwidth, meaning the radio signal 308 can carry more data, but are more susceptible to attenuation and obstacles. The presence of obstacle 302 can cause signal reflection (e.g., bouncing off surfaces), diffraction (e.g., bending around edges), and scattering (e.g., spreading out in different directions), further degrading the radio signal 308 quality. Obstacle 302 refers to any physical object or structure that may impede the transmission of radio signals between the cell site and the CPE. Obstacles 302 can include buildings, trees, hills, or other environmental features that obstruct the direct line of sight between CPE 304 and cell site 306.

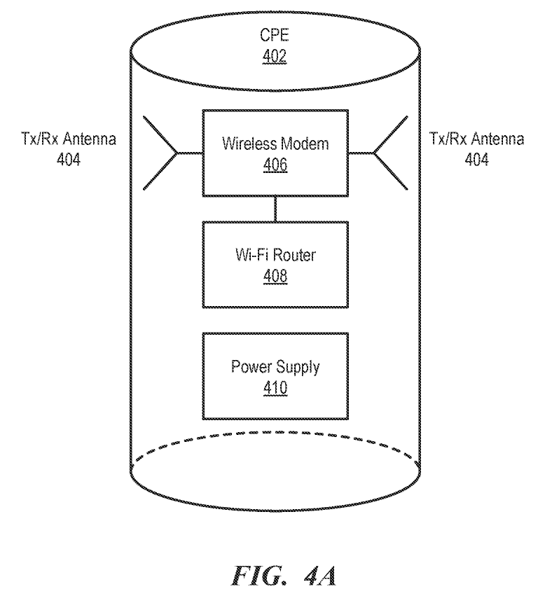

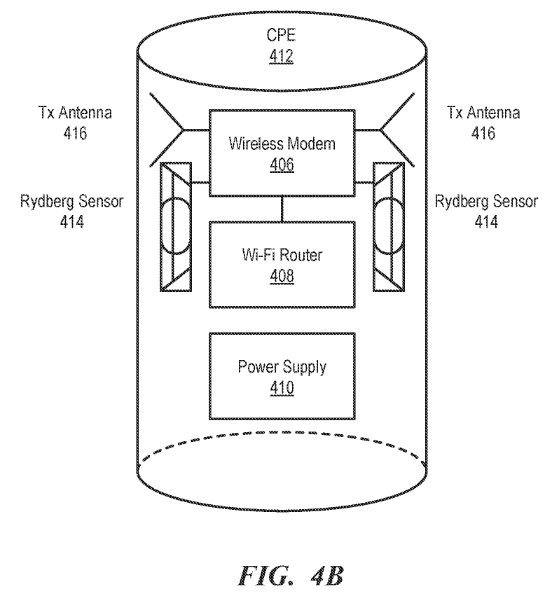

FIG. 4A is a diagram that illustrates an example CPE 402 for fixed-wireless access. CPE 402 includes antennas 404, wireless modem 406, Wi-Fi router 408, and power supply 410. CPE 402 can be fixed-wireless access devices illustrated and described in more detail with reference to FIG. 1. Implementations of CPE 402 can include different and/or additional components or can be connected in different ways.

The antennas 404 in CPE 402 receive downlink data transmissions from a cell site and transmit uplink data transmissions back to the cell site. The antennas 404 capture downlink data transmissions from the cell site and send uplink data transmissions back to the cell site, forming the primary communication link in a fixed-wireless access setup. The uplink and downlink data are the same as or similar to the uplink and downlink data with reference to FIG. 3. The cell site is the same as or similar to cell site 306 discussed with reference to FIG. 3.

The wireless modem 406 in CPE 402 serves as the primary interface between the antennas and the rest of the network. The wireless model 406 demodulates the received signals by extracting the original data from the carrier wave that transmitted the data, converts them into an IP format (a standardized format for data transmission over networks), and prepares the data for routing within the premises. The wireless modem 406 can perform functions such as baseband processing (e.g., filtering, decoding, and interpreting the raw data signals) and signal conversion (e.g., transforming the analog signals received by the antennas into digital signals) to ensure that the data is in a usable format for further distribution by the Wi-Fi router 408 (e.g., extending the connection to various devices within the premises). The performance of the wireless modem 406 directly impacts the overall speed and reliability of the internet connection provided to the user.

The Wi-Fi router 408 is communicatively coupled to the wireless modem 406 and is a device that takes the IP-formatted data from the wireless modem and distributes the data to various devices within the user's premises. The Wi-Fi router 408 can create a local wireless network (e.g., a network within the user's home or office) that allows laptops, smartphones, tablets, and other Wi-Fi-enabled devices to connect to the internet. The Wi-Fi router 408 ensures that data packets, which are small units of data transmitted over a network, are efficiently routed to and from the connected devices, providing seamless internet access throughout the home or office.

The power supply 410 is the component that provides the necessary electrical power to the CPE's antennas, wireless modem, and Wi-Fi router. The power supply 410 ensures that all these devices have a stable and reliable power source, which is used for the continuous operation of the CPE. The power supply 410 can convert the alternating current (AC) from the main power line into direct current (DC). The power supply 410 can incorporate voltage regulation and power conditioning to maintain consistent output despite fluctuations in the input power. The power supply 410 can include built-in safeguards such as surge protection to prevent damage from electrical spikes and over-current protection to avoid overheating.

FIG. 4B is a diagram that illustrates an example CPE 412 for fixed-wireless access using Rydberg atom sensors that can implement aspects of the present technology. CPE 412 includes wireless modem 406, Wi-Fi router 408, power supply 410, Rydberg sensors 414, and antennas 416. CPE 412 can be fixed-wireless access devices illustrated and described in more detail with reference to FIG. 1. Implementations of CPE 412 can include different and/or additional components or can be connected in different ways.

The wireless modem 406 in CPE 412 is equipped with Rydberg sensors 414, which use Rydberg atoms' sensitivity to electromagnetic fields to improve the CPE's ability to detect and process signals with greater precision and reliability. Thus, the wireless modem 406 can improve signal reception, mitigate interference, and improve data processing efficiency.

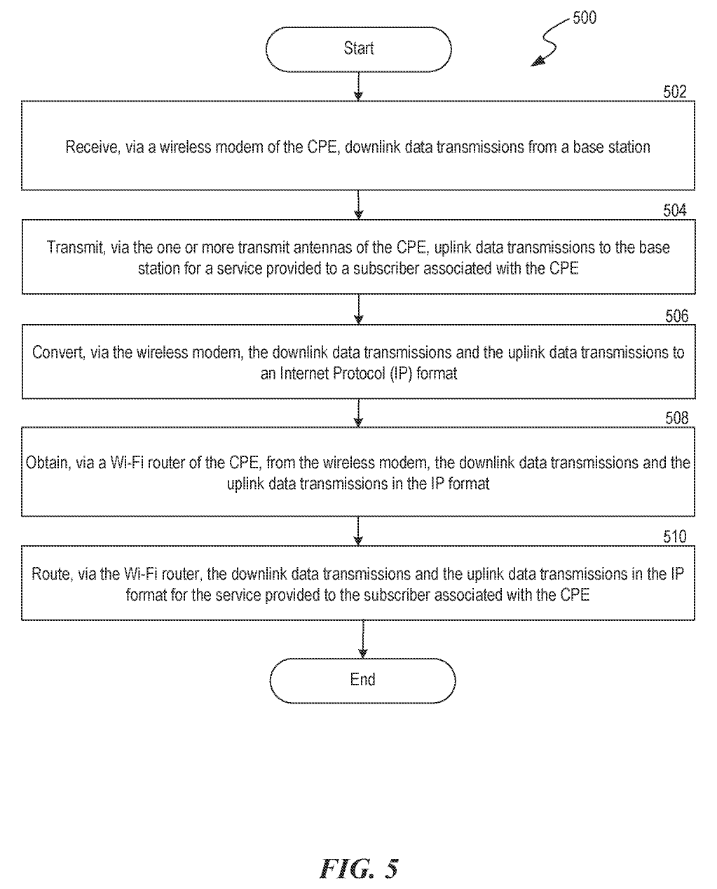

Rydberg sensors 414 use Rydberg atoms to achieve highly sensitive detection of electromagnetic fields, particularly in the RF spectrum. Rydberg atoms are atoms where one or more electrons are excited to high-energy orbitals far from the nucleus, resulting in a large atomic radius and extreme sensitivity to external electromagnetic fields. In the context of CPE 412, these properties enable Rydberg sensors 414 to detect minute variations in RF signals, which conventional antennas and modems in conventional CPEs may not perceive. The operation of Rydberg sensors 414 involves exposing vaporized alkaline element atoms—such as rubidium and/or cesium—to a specific laser wavelength. The laser excites the atoms to Rydberg states, enhancing the atoms’ sensitivity to RF signals across a designated frequency range. As RF signals interact with these excited atoms, the RF signals induce changes in the atoms’ energy levels, which can be detected and measured. This detection process provides highly accurate information about the intensity and characteristics of incoming RF signals, enabling the CPE 412 to effectively demodulate and process data transmissions. Rydberg sensors 414 contribute to improving the overall performance of FWA systems by enhancing signal reception in challenging environments. Rydberg sensors 414 can mitigate issues such as signal fading, interference from neighboring frequencies, and multipath propagation, which commonly degrade signal quality in conventional systems. Further examples of Rydberg sensors 414 are discussed with reference to FIG. 5.

In some implementations, the Rydberg sensor 414 is used solely for receiving downlink data transmissions. Consequently, the antennas 416 is, in some implementations, used solely for transmitting uplink data transmissions (e.g. in contrast with antennas 404 in FIG. 4A which perform both the transmit and receive functions). Antennas 416 can be the same as or similar to antennas 404 discussed in further detail with reference to FIG. 4A.

FIG. 5 is a flowchart that illustrates a process 500 for implementing a CPE for fixed-wireless access using Rydberg atom sensors that can implement aspects of the present technology. In some implementations, the process 500 is performed by components of example wireless devices 104 illustrated and described in more detail with reference to FIG. 1. Likewise, implementations can include different and/or additional steps or can perform the steps in different orders.

In act 502, the system receives, via a wireless modem of the CPE, downlink data transmissions from a base station. During this process, the sensors convert the received RF signals into electrical signals that can be further processed by the wireless modem. The CPE can include (1) a wireless modem with one or more sensors containing one or more Rydberg atoms and one or more transmit antennas, (2) a Wi-Fi router communicatively coupled to the wireless modem, and (3) a power supply configured to provide electrical power to the wireless modem and the Wi-Fi router. The one or more sensors can output demodulated data corresponding to the received downlink data transmissions from the base station. In some implementations, the wireless modem, the Wi-Fi router, and/or the power supply are modular components of the CPE. The power supply can provide direct current (DC) power to the one or more sensors. The CPE is the same as or similar to CPE 412 discussed with reference to FIG. 4B.

In some implementations, the one or more Rydberg atoms are housed in a glass cell. For example, the one or more Rydberg atoms can be vaporized alkaline element atoms having at least one electron excited to a high energy state. The glass cell can be hermetically sealed. The glass cell provides a controlled environment that helps maintain the integrity of the Rydberg atoms and the atoms’ sensitive quantum states. Due to glass’s transparency to laser light, the CPE can still selectively excite the atoms to their Rydberg states using specific laser wavelengths. Within the glass cell, the Rydberg atoms can be vaporized alkaline element atoms such as rubidium and/or cesium.

In some implementations, the glass cell housing the Rydberg atoms is often hermetically sealed to maintain a stable internal environment. The sealing can prevent contamination or interference from external elements to ensure the longevity and reliability of the Rydberg sensors within the CPE. The hermetic seal can protect the Rydberg atoms from environmental factors such as humidity or dust, which could otherwise affect the Rydberg atoms’ quantum properties and degrade sensor performance over time.

In some implementations, the downlink data transmissions and the uplink data transmissions are communicated in an RF band. The use of RF bands ensures that data can be transmitted reliably between the base station and the CPE without the need for physical wired connections. In some implementations, the system selects a laser wavelength of the one or more sensors to match to RF operating frequencies. By aligning the laser wavelength with the RF frequencies, the sensors can effectively interact with incoming signals.

In act 504, the system transmits, via the one or more transmit antennas of the CPE, uplink data transmissions to the base station for a service provided to a subscriber associated with the CPE, thus establishing bi-directional communication between the CPE and the service provider's network and enabling users to send data requests, commands, and/or user-generated content back to the network infrastructure. The uplink data can include user-generated information such as requests for web pages, file uploads, or real-time data streams.

In act 506, the system converts, via the wireless modem, the downlink data transmissions and the uplink data transmissions to an IP format. The wireless modem modulates these signals to align with the RF operating frequencies used by the base station, ensuring compatibility and efficient transmission. The wireless modem can eliminate baseband processing of the received downlink data transmissions from the base station by using the one or more sensors.

The wireless modem can adjust an orientation of the one or more sensors to correspond to a polarization of the downlink data transmissions, where adjusting the orientation maintains receive diversity. By dynamically adjusting the orientation of the sensors, the wireless modem ensures that it can effectively capture and demodulate the transmitted data packets, improving the reliability and quality of communication between the CPE and the network infrastructure. Receive diversity, facilitated through the orientation adjustment of sensors, plays a significant role in overcoming challenges such as multipath propagation and signal fading in wireless communications. By adapting to the polarization of incoming signals, the wireless modem enhances the ability to maintain connectivity even in environments where signal reflections or obstructions can impact signal integrity.

In act 508, the system obtains, via a Wi-Fi router of the CPE, from the wireless modem, the downlink data transmissions and the uplink data transmissions in the IP format. In act 510, the system routes, via the Wi-Fi router, the downlink data transmissions and the uplink data transmissions in the IP format for the service provided to the subscriber associated with the CPE. The system directs the data streams to their respective destinations within the local network, ensuring that each connected device receives the information necessary for the subscriber's internet service.

In some implementations, the subscriber associated with the CPE is identified via a subscriber identity module (SIM) in the wireless modem. The CPE can be configured to accommodate a SIM card slot or embedded SIM (eSIM) capability, allowing the modem to recognize and authenticate the subscriber's identity. The SIM card stores unique subscriber information, including credentials and service profiles, which can be used for establishing and maintaining connectivity with the service provider's network. The wireless modem firmware or software can include protocols for SIM card communication and authentication. In some implementations, software components within the modem manages SIM card operations, such as provisioning new services, updating subscriber profiles, and handling authentication challenges, ensuring continuous and secure connectivity for the subscriber.

### Using A Customer Premise Equipment With Rydberg Atom Sensors For Signal Detection

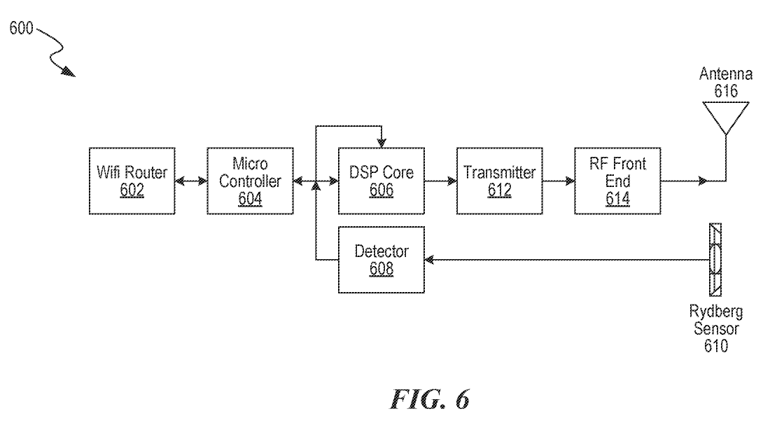

FIG. 6 is a block diagram that illustrates an example environment of using a CPE 600 with Rydberg atom sensors for signal detection that can implement aspects of the present technology. CPE 600 includes Wi-Fi router 602, microcontroller 604, digital signal processor (DSP) core 606, detector 608, Rydberg sensor 610, transmitter 612, RF front end 614, and antenna 616. CPE 600 can be the same as or similar to the fixed-wireless access devices illustrated and described in more detail with reference to FIG. 1, and/or can be the same as or similar to CPE 402 discussed with reference to FIG. 4B. Implementations of CPE 600 can include different and/or additional components or can be connected in different ways.

The Wi-Fi router 602 manages wireless communication of CPE 600 by managing the distribution of internet connectivity to various devices within the premises by using RF signals. For example, the Wi-Fi router 602 can scan for available frequency channels to avoid interference and select a channel to broadcast a Service Set Identifier (SSID) to allow devices within the premises to identify and connect to the network. The Wi-Fi router 602 establishes and maintains the wireless network by routing data packets to and from connected devices (e.g., CPE 600). The Wi-Fi router 602 can operate on standard Wi-Fi protocols (e.g., IEEE 802.11ac, IEEE 802.11ax). Wi-Fi router 602 can be the same as or similar to Wi-Fi router 408 discussed with reference to FIG. 4B.

The microcontroller 604 is the central processing unit of the CPE 600, and executes firmware and software instructions used during the functioning of the CPE 600. The microcontroller 604 manages tasks such as signal processing, data routing, and communication protocols, and coordinates the activities of components within the CPE 600 such as the Wi-Fi router 602, DSP core 606, and Rydberg sensors 610. The microcontroller 604 can include integrated peripherals such as timers, communication interfaces (e.g., UART, SPI, I2C), and/or memory (e.g., RAM, flash) to manage data storage, and/or interface with other hardware components.

The DSP core 606 manages mathematical computations required for signal processing. The DSP core 606 processes digital signals received from the Wi-Fi router 602 and prepares the digital signals for subsequent transmission. The DSP core 606 can include specialized hardware units for filtering out noise, performing fast Fourier transforms to analyze frequency components, and/or modulating or demodulating signals to convert the signals between analog and digital forms.

The detector 608 can identify and capture electromagnetic fields associated with downlink data transmissions from the base station using Rydberg sensors 610. The detector 608 can interact in conjunction with the Rydberg sensor 610 to detect the signals while mitigating interference from metallic components and other sources of distortion. The detector 608 can include components such as low-noise amplifiers and filters to improve signal detection sensitivity and selectivity.

The Rydberg sensor 610 uses Rydberg atoms to detect electromagnetic fields with high sensitivity and precision. The Rydberg sensor 610 can be the same as or similar to Rydberg sensors 414 discussed with reference to FIG. 4B. The Rydberg sensor 610 can identify downlink data transmissions from the base station. The Rydberg sensor 610's ability to avoid electric field distortion and impedance from metallic members allows it to maintain the signal integrity within the CPE. The Rydberg sensor 610 typically operates by exciting Rydberg atoms to high principal quantum numbers, where they exhibit strong interactions with external electromagnetic fields.

When the Rydberg sensor 610 detects electromagnetic fields associated with downlink data transmissions from the base station, the Rydberg sensor 610 sends these signals to the detector 608. The detector 608 can filter, amplify and/or clean the signals, and forward the signals to the DSP core 606. For example, the low-noise amplifiers in detector 608 can amplify the weak signals detected by the Rydberg sensor 610. The microcontroller 604 ensures that the data processed by the DSP core 606 is routed to the appropriate modules within the CPE 600, such as the Wi-Fi router 602 for distribution to connected devices.

Once the DSP core 606 has processed the digital signals, the transmitter 612 can convert the signals into RF signals that can be transmitted over the air to send uplink data transmissions from the CPE 600 to the base station. The transmitter 612 can include components such as power amplifiers, modulators, and/or up-converters to generate the RF signals for transmission. Power amplifiers increase the strength of the processed digital signals to ensure that the signals have sufficient power to reach the base station without significant degradation (e.g., cause the signal to be below the sensitivity threshold of the receivers). Modulators are used to convert the digital signals by varying a carrier signal's properties, such as its amplitude, frequency, or phase. Up-converters shift the frequency of the modulated signals to a particular RF band for transmission, ensuring that the signals are transmitted within designated frequency bands allocated by regulatory authorities and avoiding interference with other communication systems.

After the transmitter 612 has generated the RF signals, the signals are managed by the RF front end 614. The RF front end 614 manages the transmission and reception of RF signals. The RF front end 614 can include components such as amplifiers, filters, and/or mixers that prepare signals for transmission and reception. The RF front end 614 ensures that signals are of the appropriate strength and quality for effective communication and can include low-noise amplifiers for signal reception, power amplifiers for signal transmission, and bandpass filters to select the desired frequency bands.

The antenna 616 is the physical component that transmits and receives RF signals. The antenna 616 converts electrical signals from the RF front end 614 into electromagnetic waves for transmission and vice versa for reception. The antenna 616 can be configured to operate within the specified frequency range. The antenna 616 can include multiple elements to support MIMO to, for example, improve data throughput and reliability by utilizing multiple signal paths. Antenna 616 can be the same as or similar to the antennas 404 discussed with reference to FIG. 4B.

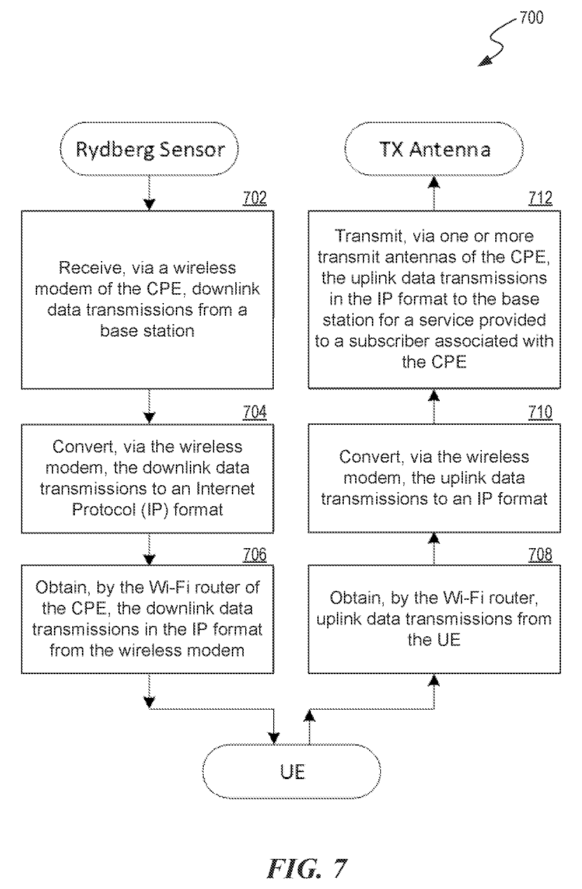

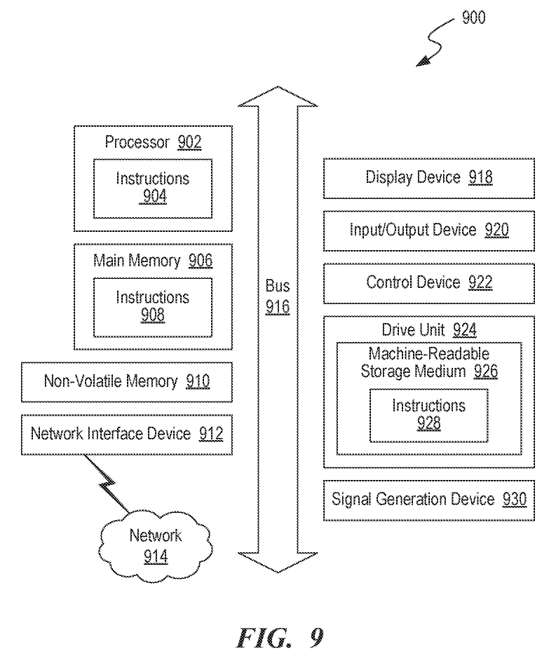

FIG. 7 is a flowchart that illustrates a process 700 for implementing a CPE (e.g., CPE 600) with Rydberg atom sensors for signal detection that can implement aspects of the present technology. In some implementations, the process 700 is performed by a system including components of the example computer system 900 illustrated and described in more detail with reference to FIG. 9. The system can be implemented on a terminal device, a server, or on a telecommunications network core. Implementations can include different and/or additional steps or can perform the steps in different orders.

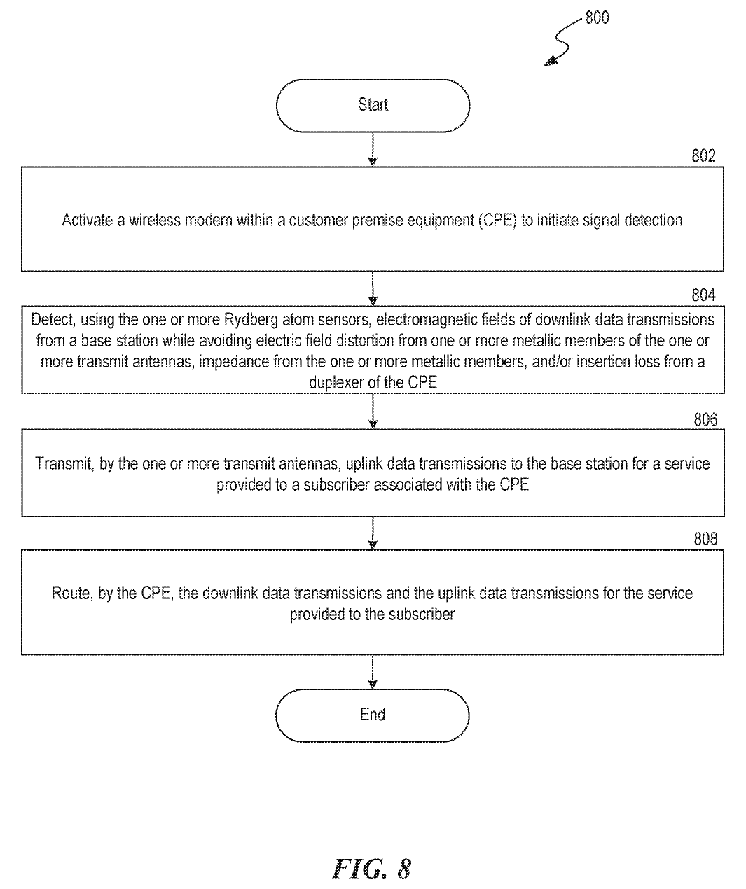

In act 702, the Rydberg sensor receives, via a wireless modem of the CPE, downlink data transmissions from a base station. Using the Rydberg sensors, the CPE detects electromagnetic fields of downlink data transmissions from a base station. The detection can be performed while avoiding electric field distortion from metallic members of the transmit antennas, impedance from these metallic members, and insertion loss from a duplexer within the CPE. Methods of detecting electromagnetic fields using Rydberg sensors are discussed in further detail with reference to FIG. 8.

Following the detection of downlink data transmissions, the process 700 can proceed to act 704. In act 704, the wireless modem of the CPE can convert the downlink data transmissions into an IP format to ensure that the downlink data is in a standardized format and enable the integration of the downlink data into the local network and for subsequent distribution to various devices within the premises. For example, the wireless modem can demodulate the received signals. Methods of converting data transmissions to IP format are discussed in further detail with reference to FIG. 8.

Once the data is converted to IP format, the process 700 can proceed to act 706. In act 706, the Wi-Fi router of the CPE obtains the downlink data transmissions in the IP format from the wireless modem. The Wi-Fi router can manage the data flow within the premises covered by the CPE to ensure that connected devices receive the corresponding data for internet access. Methods of obtaining and routing data transmissions are discussed in further detail with reference to FIG. 8.

After obtaining the downlink data, the process 700 can continue to act 708. In act 708, the Wi-Fi router of the CPE obtains uplink data transmissions from the UE. For example, the Wi-Fi router collects data generated by devices within the premise of the CPE, such as requests for web pages, file uploads, and/or real-time data streams. The Wi-Fi router can manage the data’s transmission back to the base station. Methods of obtaining uplink data transmissions are discussed in further detail with reference to FIG. 8. In act 710, one or more transmit antennas of the CPE transmits the uplink data transmissions in the IP format to the base station for a service provided to a subscriber associated with the CPE.

FIG. 8 is a flowchart that illustrates a process 800 for implementing a CPE (e.g., CPE 600) with Rydberg atom sensors for signal detection that can implement aspects of the present technology. In some implementations, the process 800 is performed by components of example wireless devices 104 illustrated and described in more detail with reference to FIG. 1. Likewise, implementations can include different and/or additional steps or can perform the steps in different orders.

In act 802, the CPE activates a wireless modem within a CPE to initiate signal detection. The wireless modem can include one or more Rydberg sensors containing one or more transmit antennas having one or more Rydberg atoms, microcontroller 604, DSP core 606, detector 608, Rydberg sensor 610, transmitter 612, RF front end 614, and/or antenna 616. In some embodiments, the wireless modem is the same as or similar to wireless modem 406 in FIG. 4. Upon activation, the modem's internal microcontroller (e.g., microcontroller 604) can execute a series of initialization routines, which can include self-diagnostics and/or synchronization with the base station's timing signal. The antennas can include multiple elements to support various communication techniques such as MIMO, to improve data throughput and reliability by using multiple signal paths.

In act 804, the CPE detects, using the one or more Rydberg atom sensors, electromagnetic fields of downlink data transmissions from a base station while avoiding electric field distortion from one or more metallic members of the one or more transmit antennas, impedance from the one or more metallic members, and/or insertion loss from a duplexer of the CPE. Upon activation of CPE, the Rydberg sensors can detect electromagnetic fields associated with downlink data transmissions from the base station. The Rydberg sensors' high sensitivity allows them to accurately capture these signals while avoiding electric field distortion from metallic components of the antennas. To further mitigate the effects of electric field distortion, the DSP core (e.g., DPS core 606) within the modem can perform tasks such as filtering, demodulation, and/or error correction to extract the transmitted data from the detected signals. The DSP core helps reduce any residual noise or interference that may have been introduced during signal detection.

Impedance from metallic members of the transmit antennas can affect the quality of the detected signals. Impedance mismatches can lead to signal reflections and losses, which can degrade the overall performance of the CPE. However, by using Rydberg atom sensors, impedance typically associated with metallic members and transmission lines are removed, lowering electric field distortion. Rydberg atom sensors can directly detect electromagnetic fields through the interaction of Rydberg states with external fields, and, in some embodiments, does not use metallic transmission lines or other components that introduce impedance. Additionally, insertion loss from a duplexer of the CPE can impact the quality of the detected signals. A duplexer is a device that allows simultaneous transmission and reception of signals on the same antenna by separating the transmit and receive paths. Insertion loss occurs when some of the signal power is lost as it passes through the duplexer. By using Rydberg sensors in the CPE, duplexers and/or filters can be removed, allowing for dedicated transmit and receive paths in the modem. The dedicated transmit and receive paths ensure that there is no signal interference or loss due to duplexers, leading to lower insertion loss from duplexers.

Rydberg atoms are atoms in which one or more electrons have been excited to a high principal quantum number, denoted as n (e.g., when n is greater than 10). These high n states are characterized by large electron orbits and spatial separation between the nucleus and the excited electron. For instance, the radius of the electron orbit in a Rydberg atom with n = 50 can be approximately 1250 times larger than that of the ground state (since the radius scales as n²). As a result, Rydberg atoms have exaggerated properties, such as large electric dipole moments and strong interactions with external electromagnetic fields. Rydberg atoms are highly sensitive to external electromagnetic fields, allowing them to detect even weak signals with high precision. The sensitivity is achieved through the use of various laser excitation techniques, which excite the Rydberg atoms to high principal quantum number states. To create Rydberg atoms, the atoms are initially prepared in a low-energy ground state. A series of laser pulses can be used to excite the atoms to intermediate energy levels, eventually reaching the desired high n Rydberg state.

In some embodiments, the detection of electromagnetic fields using Rydberg atoms includes measuring the shifts in the energy levels of the atoms caused by the external fields. The shifts, known as Stark shifts, can be proportional to the strength of the electric field. By measuring the Stark shifts, the CPE can determine the magnitude and direction of the external electromagnetic fields. In some embodiments, Autler-Townes splitting is used to measure the energy levels of Rydberg atoms. When a strong microwave or radiofrequency field is applied to the Rydberg atoms, it induces a splitting of the energy levels (e.g., Autler-Townes splitting). The magnitude of the splitting can be proportional to the strength of the applied field. By measuring the splitting, the CPE can determine the strength of the external electromagnetic field.

In act 806, the CPE transmits, by the one or more transmit antennas, uplink data transmissions to the base station for a service provided to a subscriber associated with the CPE using methods similar to act 508 in FIG. 5. The subscriber can be associated with the CPE and identified via a subscriber identity module in the wireless modem. The CPE can convert, via the wireless modem, the downlink data transmissions and the uplink data transmissions to an IP format. The CPE can obtain, via a Wi-Fi router of the CPE, from the wireless modem, the downlink data transmissions and the uplink data transmissions in the IP format.

In act 808, the CPE routes, by the CPE, the downlink data transmissions and the uplink data transmissions for the service provided to the subscriber. In some embodiments, the CPE can monitor, using the wireless modem, a signal strength and a signal quality of the downlink data transmissions detected by the Rydberg sensors. The signal strength can be a power level of the downlink data transmissions. The signal quality can include a clarity and an integrity of the downlink data transmissions based on, for example, a signal-to-noise ratio and/or a bit error rate of the downlink data transmissions. In some embodiments, the CPE can disable at least one duplexer within the wireless modem. The at least one duplexer can cause path loss between the electromagnetic fields and the one or more transmit antennas.

### Computer System

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 900 can perform operations in real time, in near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### Remarks

The terms “example” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number can also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that can be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A method for operating customer premise equipment (CPE) for fixed-wireless access (FWA), the method comprising:
activating a wireless modem within the CPE to initiate signal detection,
wherein the wireless modem includes one or more Rydberg sensors containing one or more transmit antennas having one or more Rydberg atoms;
detecting, using the one or more Rydberg sensors, electromagnetic fields of downlink data transmissions from a base station while avoiding electric field distortion from one or more metallic members of the one or more transmit antennas, impedance from the one or more metallic members of the one or more transmit antennas, and insertion loss from a duplexer of the CPE;
transmitting, via the one or more transmit antennas, uplink data transmissions to the base station for a service provided to a subscriber associated with the CPE,
wherein the subscriber associated with the CPE is identified via a subscriber identity module in the wireless modem;
converting, via the wireless modem, the downlink data transmissions and the uplink data transmissions to an Internet Protocol (IP) format;
obtaining, via a Wi-Fi router of the CPE, from the wireless modem, the downlink data transmissions and the uplink data transmissions in the IP format; and
routing, via the Wi-Fi router, the downlink data transmissions and the uplink data transmissions in the IP format for the service provided to the subscriber associated with the CPE.

2. The method of claim 1, comprising:
monitoring, using the wireless modem, a signal strength and a signal quality of the downlink data transmissions detected by the Rydberg sensors,
wherein the signal strength is a power level of the downlink data transmissions, and
wherein the signal quality includes a clarity and an integrity of the downlink data transmissions based on at least one of: a signal-to-noise ratio or a bit error rate of the downlink data transmissions.

3. The method of claim 1, comprising:
disabling at least one duplexer within the wireless modem,
wherein the at least one duplexer is configured to cause path loss between the electromagnetic fields and the one or more transmit antennas.

4. The method of claim 1,
wherein the one or more Rydberg atoms are housed in a glass cell,
wherein the one or more Rydberg atoms are vaporized alkaline element atoms having at least one electron excited to a high energy state, and
wherein the glass cell is hermetically sealed.

5. The method of claim 1, wherein the wireless modem is configured to eliminate baseband processing of the detected downlink data transmissions from the base station by using the one or more Rydberg sensors.

6. The method of claim 1,
wherein the wireless modem is configured to adjust an orientation of the one or more Rydberg sensors to correspond to a polarization of the downlink data transmissions, and
wherein adjusting the orientation maintains receive diversity.

7. The method of claim 1, wherein the wireless modem is configured to reduce interference in receiving the downlink data transmissions by using the one or more Rydberg sensors.

8. A non-transitory, computer-readable storage medium comprising instructions recorded thereon, wherein the instructions when executed by at least one data processor of a computer system, cause the computer system to:
activate a wireless modem within a customer premise equipment (CPE) to initiate signal detection,
wherein the wireless modem includes one or more Rydberg sensors containing one or more transmit antennas having one or more Rydberg atoms;
detect, using the one or more Rydberg atom sensors, electromagnetic fields of downlink data transmissions from a base station while avoiding electric field distortion from one or more metallic members of the one or more transmit antennas, impedance from the one or more metallic members, and/or insertion loss from a duplexer of the CPE;
transmit, by the one or more transmit antennas, uplink data transmissions to the base station for a service provided to a subscriber associated with the CPE; and
route, by the CPE, the downlink data transmissions and the uplink data transmissions for the service provided to the subscriber.

9. The non-transitory, computer-readable storage medium of claim 8, wherein the subscriber associated with the CPE is identified via a subscriber identity module in the CPE.

10. The non-transitory, computer-readable storage medium of claim 8, wherein the one or more Rydberg sensors are configured to output demodulated data corresponding to the detected downlink data transmissions from the base station.

11. The non-transitory, computer-readable storage medium of claim 8, wherein the downlink data transmissions and the uplink data transmissions are communicated in a radio frequency (RF) band.

12. The non-transitory, computer-readable storage medium of claim 8, wherein the instructions cause the computer system to:
select a laser wavelength of the Rydberg sensors to match to radio frequency (RF) operating frequencies.

13. The non-transitory, computer-readable storage medium of claim 8, wherein the wireless modem is a modular component of the CPE.

14. The non-transitory, computer-readable storage medium of claim 8, wherein the CPE comprises a power supply configured to provide direct current power to the Rydberg sensors.

15. A system comprising:
at least one hardware processor; and
at least one non-transitory memory storing instructions, which, when executed by the at least one hardware processor, cause the system to:
activate a wireless modem within a customer premise equipment (CPE) to initiate signal detection,
wherein the wireless modem includes one or more Rydberg sensors containing one or more transmit antennas having one or more Rydberg atoms;
detect, using the one or more Rydberg sensors, electromagnetic fields of downlink data transmissions from a base station while avoiding electric field distortion from one or more metallic members of the one or more transmit antennas; and
transmit, via the one or more transmit antennas, uplink data transmissions to the base station for a service provided to a subscriber associated with the CPE.

16. The system of claim 15, wherein the system is caused to:
monitor, using the wireless modem, a signal strength and a signal quality of the downlink data transmissions detected by the Rydberg sensors,
wherein the signal strength is a power level of the downlink data transmissions, and
wherein the signal quality includes a clarity and an integrity of the downlink data transmissions based on at least one of: signal-to-noise ratio or bit error rate of the downlink data transmissions.

17. The system of claim 15, wherein the system is caused to:
disable at least one duplexer within the wireless modem,
wherein the at least one duplexer is configured to cause path loss between the electromagnetic fields and the one or more transmit antennas.

18. The system of claim 15, wherein detecting the electromagnetic fields avoids impedance from a duplexer of the one or more transmit antennas, and/or insertion loss from a duplexer of the CPE .

19. The system of claim 15, wherein the wireless modem is configured to eliminate baseband processing of the detected downlink data transmissions from the base station by using the Rydberg sensors.

20. The system of claim 15,
wherein the wireless modem is configured to adjust an orientation of the Rydberg sensors to correspond to a polarization of the downlink data transmissions, and
wherein adjusting the orientation maintains receive diversity.
